(19) United States
(12) Patent Application Publication
(10) Pub. No.: US 2007/0086382 A1
(43) Pub. Date: Apr. 19, 2007

(54) Methods of network access configuration in an IP network

(76) Inventors: Vidya Narayanan, Schaumburg, IL (US); Madjid R. Nakhjiri, Palatine, IL (US); Narayanan Venkitaraman, Schaumburg, IL (US)

Correspondence Address: MOTOROLA, INC., 1303 EAST ALGONQUIN ROAD, IL01/3RD, SCHAUMBURG, IL, 60196, US

(21) Appl. No.: 11/251,728

(22) Filed: Oct. 17, 2005

(51) Int. Cl. H04Q 7/00

(52) U.S. Cl. 370/331

(57) ABSTRACT

Apparatus performs a method that includes the steps of: receiving (210) a location parameter request for a mobile entity; determining (220) a set of location parameters corresponding to the mobile entity, the set of location parameters comprising at least an identification of a current point of attachment of the mobile entity; and communicating (230) a response comprising at least a portion of the determined set of location parameters. Another method includes the steps of: receiving (310) a message comprising a set of location parameters corresponding to the mobile entity, wherein the set of location parameters is based on an identification of a current point of attachment of the mobile entity; and setting (320) a network access configuration for the mobile entity based on the set of location parameters.

### FIELD OF THE INVENTION

The present invention relates generally to Internet Protocol (IP) enabled networks and more specifically to determining location parameters for use in determining and setting a mobile entity's network access configurations based on the location of the mobile entity in a network.

### BACKGROUND OF THE INVENTION

Mobile IP technology is a solution for seamless mobility on a network such as, for instance, the global Internet or a private network that is scalable, robust and secure, and that allows roaming or mobile entities (MEs) (also commonly referred to in the art as mobile nodes) such as radios, phones, laptops, Personal Digital Assistants (PDAs), etc., to maintain ongoing communications while changing their point of attachment to the network. Mobile IP protocols are described in the Internet Engineering Task Force (IETF) Request for Comments (RFC) 3344 titled “IP Mobility Support for IPv4” (also commonly referred to in the art as MIPv4 and wherein IPv4 is described in RFC 791) and in RFC 3775 titled “Mobility Support in IPv6” (also commonly referred to in the art as MIPv6 and wherein IPv6 is described in RFC 2460). Both MIPv4 and MIPv6 are referred to herein as standard Mobile IP.

More specifically, in accordance with standard Mobile IP, each mobile entity is always identified by a home address (HoA) regardless of its current point of attachment to the network, which provides information about its point of attachment to a home network. However, when the mobile entity is connected to the network outside of its home network, i.e. when visiting a foreign network or a foreign domain, the mobile entity is also associated with a care-of address (CoA) that provides information about its current point of attachment. A point of attachment of an entity on a network is defined herein as a location on the network to which the entity is connected either directly or indirectly, wherein the point of attachment may be characterized, for example, by an IP subnet or an identity of an access node such as an access router.

In a Mobile IP system there may further be a need for security mechanisms. For example, a private network may control what entities outside of the network may obtain access to the network through the use of a logical entity called a Virtual Private Network (VPN) gateway and may further control what traffic originating outside of the private network is allowed on the network. Moreover, a private network may further dictate that the traffic flowing inside and outside of the network be secured using some form of cryptographic technology to limit access to who is allowed to view the traffic.

One protocol that may be used for network access and traffic security is the IPsec protocol as described in RFC 2401 titled “Security Architecture for the Internet Protocol.” IPsec provides security services at the network layer (or level) (in the well know Open Standards Interconnect (OSI) networking model) by enabling a system to select required security protocols, determine the algorithm(s) to use for the service(s), and put in place any cryptographic keys required to provide the requested services. IPsec can be used to protect one or more “paths” (also referred to in the art as tunnels) between a pair of hosts, between a pair of security gateways, or between a security gateway and a host. The term “security gateway” (which may be used interchangeably with the term “VPN gateway”) refers to an intermediate system that implements the IPsec protocol. For example, a router or a firewall implementing IPsec may be considered a security or VPN gateway. The set of security services that IPsec can provide includes access control, connectionless integrity, data origin authentication, rejection of replayed packets (a form of partial sequence integrity), confidentiality (encryption), and limited traffic flow confidentiality.

Where in the network a mobile entity is connected may impact how the mobile entity should behave, thereby, making location detection for the mobile entity desirable. For example, location detection mechanisms are needed at the network level to enable a decision to be made regarding appropriate Mobile IP and VPN actions by a mobile entity based on its current location. From a network perspective, two distinctions need to be made—home subnet vs. foreign subnet and home domain vs. visited domain.

The detection of home subnet vs. foreign subnet is important from both a mobility and a VPN perspective. When located on the home subnet, the ME does not need a Mobile IP tunnel or a VPN tunnel. This is because two conditions may be assumed when a ME is attached to the home subnet: (1) the home subset is internally secure; and (2) the ME may be reached using its HoA without the additional header overhead of Mobile IP. However, when located on a foreign subnet, the ME may need to use both Mobile IP and a VPN tunnel because neither of the above two conditions may continue to apply. Home domain vs. visited domain is important from a VPN perspective. Being in the home domain may imply that the ME is within the internally secure private network and hence, a VPN is not required. However, mobility, using Mobile IP, is still required where a ME is not on its home subnet.

There are some known techniques that address location determination. For example, in standard Mobile IP, “home” can simply be detected by receiving a Mobile IP Home Agent Advertisement (HAA) on the subnet on which the ME is located. When the ME does not know its HA, it can use its Network Access Identifier (NAI) to compare it to the NAI in the HAA (if present) to determine if it is home. However, this method of detection has security vulnerabilities. For instance, since standard Mobile IP does not provide any method of securing the agent advertisement messages, an entity sending an unauthorized HAA can fool the ME into thinking it is home and potentially compromise secure communications.

Another technique uses a Mobile IP Proxy to indicate to a mobile entity whether it has connected to an internal network versus a remote network. However, this distinction is not enough information in certain instances. For example, the distinction does not indicate where in the “internal” network the mobile entity is located, e.g., the home subnet or another subnet in the internal network. So, the mobile entity could not optimize its network access configuration by refraining from using Mobile IP when it isn't needed. Similarly, other network access parameters such as use of bypass mode wherein the mobile node can use its CoA as the source address in a packet may depend on where in the network the mobile is connected.

Thus, there exists a need for a secure means for indicating location for a ME that would enable a network access configuration of the ME to be optimally set based on its location in a network.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 illustrates a network having entities that are configured in accordance with embodiments of the present invention;

FIG. 2 illustrates a flow diagram of a method in accordance with an embodiment of the present invention;

FIG. 3 illustrates a flow diagram of a method in accordance with an embodiment of the present invention;

FIG. 4 illustrates a registration request in accordance with an embodiment of the present invention;

FIG. 5 illustrates a registration request in accordance with an embodiment of the present invention;

FIG. 6 illustrates a registration reply in accordance with an embodiment of the present invention; and

FIG. 7 illustrates a registration reply in accordance with an embodiment of the present invention.

### DETAILED DESCRIPTION OF THE INVENTION

Before describing in detail embodiments that are in accordance with the present invention, it should be observed that the embodiments reside primarily in combinations of method steps and apparatus components related to a method and apparatus for location parameter determination in a Mobile IP network. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein. Thus, it will be appreciated that for simplicity and clarity of illustration, common and well-understood elements that are useful or necessary in a commercially feasible embodiment may not be depicted in order to facilitate a less obstructed view of these various embodiments.

In this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that embodiments of the invention described herein may be comprised of one or more conventional processors and unique stored program instructions that control the one or more processors to implement, in conjunction with certain non-processor circuits, some, most, or all of the functions of the method and apparatus for location parameter determination in a Mobile IP network described herein. The non-processor circuits may include, but are not limited to, a radio receiver, a radio transmitter, signal drivers, clock circuits, power source circuits, and user input devices. As such, these functions may be interpreted as steps of a method to perform the location parameter determination in a Mobile IP network described herein. Alternatively, some or all functions could be implemented by a state machine that has no stored program instructions, or in one or more Application Specific Integrated Circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

Generally speaking, pursuant to the various embodiments, upon power-up or handover of a mobile entity, the mobile entity sends an authenticated location parameter request that is received by a location server attached to the mobile entity's home network. In one embodiment, the location parameter request is included as a location extension to a standard Mobile IP registration request (MIPv4) or binding update (MIPv6), and the registration request or binding update further includes information about the mobile entity's current point of attachment. Moreover, the location server may comprise one or more of a home agent, a Virtual Private Network (VPN) gateway and an Authentication Authorization and Accounting (AAA) server or may comprise a separate server. Responsive to the request, the location server determines a set of location parameters using the information in the registration request regarding the mobile entity's current point of attachment, wherein the set of location parameters may comprises an identification of a current point of attachment of the mobile entity and/or a network access configuration setting instruction for the mobile entity based on the current point of attachment of the mobile entity.

The location server sends a secured (e.g., an authenticated or encrypted) response, e.g., a registration reply message (MIPv4) or binding acknowledgement (MIPv6) including a location extension, that is received by the mobile entity and that comprises at least a portion of the set of location parameters in the location extension. In one instance, the mobile entity receives, in the secured response, the identification of its current point of attachment, and the mobile entity dynamically determines and sets its network access configurations based on the identified point of attachment (e.g., the mobile entity sets its VPN and Mobile IP configurations). In another instance, the mobile entity receives, in the secured response, a network access configuration setting instruction and configures itself in accordance with the instruction. The instruction may be a temporary instruction that is cancelled by a subsequent reconfiguration instruction, to thereby reconfigure the network access configuration in the mobile entity, or a time out.

In this manner, it can be determined whether a mobile entity is attached to its home subnet vs. a foreign subnet and whether it is attached to its home domain vs. a foreign domain and, at a minimum, the mobile entity's VPN and mobility configurations can be optimized based upon its location. In other embodiments additional location parameters such as the type of network (e.g., 802.11, 802.16, General Packet Radio Service (GPRS), etc.) can be sent to the mobile entity in the authenticated response from the location server to further optimize settings in the mobile entity such as settings in particular applications residing on the mobile entity. Those skilled in the art will realize that the above recognized advantages and other advantages described herein are merely exemplary and are not meant to be a complete rendering of all of the advantages of the various embodiments of the present invention.

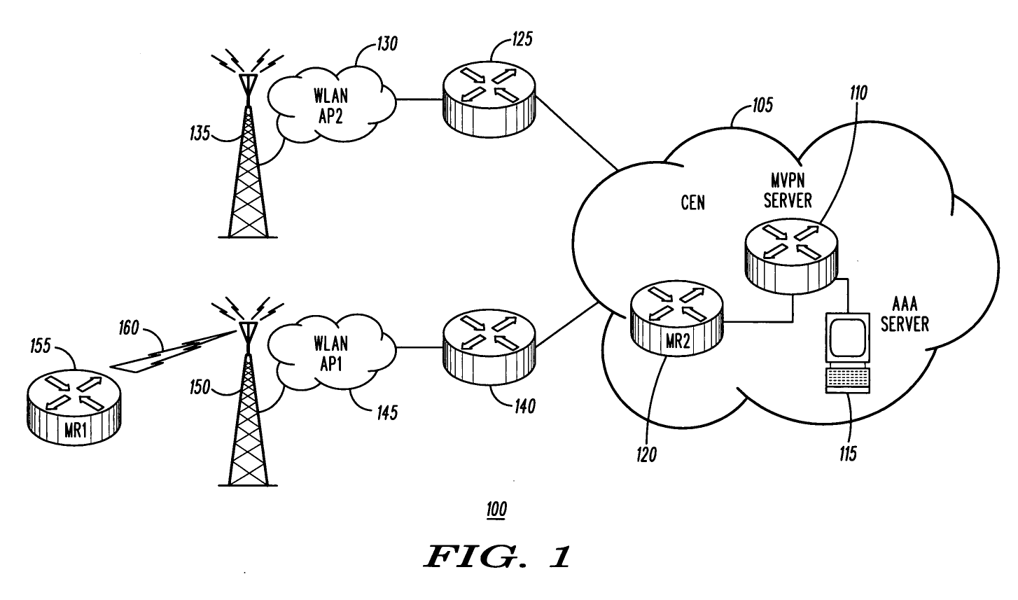

Referring now to the drawings, and in particular FIG. 1, a communication network is shown and indicated generally at 100. Network 100 is one example of a network that may implement various embodiments of the present invention. Network 100 comprises, for example: a customer enterprise network (CEN) 105 that may be a private network owned by a Public Safety agency, for instance, and having a plurality of fixed entities and mobile entities having CEN 105 as their home network; a wireless local area network (WLAN) 130 that may be a public or a private network coupled to CEN 105, and a WLAN 145 that may be a public or a private network coupled to CEN 105. In this illustrative network, both WLAN 130 and WLAN 145 are shown respectively indirectly connected to CEN 105 via an edge router 125 and an edge router 140. Such coupling may be via suitable wires and cables using wired techniques well known in the art.

In general CEN 105, WLAN 130 and WLAN 145 comprise various infrastructure elements as is well known in the art. These infrastructure elements may include, but are not limited to, access points, base stations, various servers (e.g., Authentication Authorization and Accounting (AAA) servers, Virtual Private Network (VPN) servers, etc.) and the like. A MVPN server 110 and an AAA server 115 comprising the infrastructure of CEN 105 and access points (AP1) 150 and AP2 (135) (which in this embodiment are each base stations), respectively, comprising the infrastructure of WLANs 145 and 130 are shown for illustrative purposes. An access point is a layer 2 (in the well known OSI networking model) device that provides a wireless link connection to a mobile node in a WLAN.

In this illustrative network 100, MVPN server 110 comprises a router on CEN 105 and further comprises a HA and a VPN gateway co-located on this single server. Accordingly, both mobility management (in accordance with MIPv4 and/or MIPv6) and VPN gateway functions for CEN 105 (in accordance with IPSec or any other suitable protocol(s)) are provided by server 110. In such a co-located configuration that implements Mobile IP and IPSec, an IPSec tunnel can be maintained with a ME across different points of attachment as the ME roams. Furthermore, IPSec tunnels created using the IPSec protocol are usually based on the HoA of the ME and are, thereby, inside respective MIP tunnels when both MIP and IPSec tunnels are required for communication between two endpoints in network 100. AAA server 115 comprises a computer that provides authentication, authorization and accounting functions for CEN 105 in accordance with the RADIUS protocol (or any other suitable protocol(s)) and is thus also referred to in the art as a RADIUS server. MVPN server 110, accordingly, further comprises a AAA client (implementing the RADIUS protocol) to enable it to communicate with AAA server 115.

It should be understood by those skilled in the art that the physical implementation of the servers 110 and 115 may be varied depending on the particular application. However, each server 110 and 115 generally comprises at least some form of hardware (such as one or more processors coupled to suitable memory and/or ASIC(s)) for executing software stored in the memory to perform its intended functionality, including its functionality in accordance with the embodiments herein. One or more of servers 110 and 115 may further comprises a transceiver for transmitting and receiving packets in network 100, wherein a packet is defined generally herein as a message transmitted over a network from one entity to another and may include, but is not limited to, an IP datagram.

Either one of or both servers 110 and 115 may include functionality (including all necessary software and hardware, such as processors, memory, a transceiver, etc.) for implementing the various embodiments described herein. It should be further understood by those skilled in the art that the various logical entities of a HA, a AAA server and a VPN gateway may in other embodiments be included on one physical device, all on separate physical devices or any combination thereof. Moreover, it should be further understood that various functionality in accordance with embodiments described herein may be performed in a logical entity generally referred to herein as a “location server” that may comprise one or more of the logical entities of a HA, a AAA server and a VPN gateway. In other embodiments, the location server may be a separate logical entity that may comprise a separate physical device from the HA, AAA server and VPN gateway or may be co-located with any one or more of those logical entities.

Those skilled in the art will recognize and appreciate that the specifics of this illustrative example are not specifics of the invention itself and that the teachings set forth herein are applicable in a variety of alternative network topologies. For example, since the teachings described do not depend on the type of network topology (including the number and type of infrastructure elements contained therein), they can be applied to any type of network topology. As such, other alternative implementations of using different types of network topologies including ones associated with other types of networks such as Wide Area Networks (WANs), Radio Access Networks (RANs), Vehicular Access Networks (VANs), etc. are contemplated and are within the scope of the various teachings described herein.

Entities, including both fixed and mobile entities, may use network 100 for communicating information, for instance, in the form of packets. Illustrated in FIG. 1 are mobile routers MR1 155 and MR2 120. A fixed entity or node is either a host (no forwarding functionality) or a router (forwarding functionality) that is unable to change its point of attachment to network 100 or change its IP address without breaking open sessions. A mobile entity or node, however, is defined herein as an IP device that is capable of changing its point of attachment to network 100 by being configured for using standard Mobile IP.

A mobile entity may be either a mobile host or a mobile router. A mobile host is an end host that is capable of sending and receiving packets, that is, being a source or destination of traffic, but not a forwarder of traffic. A mobile router, on the other hand, is capable of forwarding packets between two or more interfaces. It should be understood by those skilled in the art that the various entities (including routers and hosts) that communicate over network 100 generally comprise suitable memory and one or more processors (or ASICs) for storing and executing software to perform methods described below in accordance with embodiments herein and may further comprise a suitable transceiver and interfaces for transmitting and receiving packets within network 100, a AAA client (implementing the RADIUS protocol) for communicating with AAA server 115, a Domain Name System (DNS) client, a Dynamic Host Configuration Protocol (DHCP) client, etc., as is well known in the art.

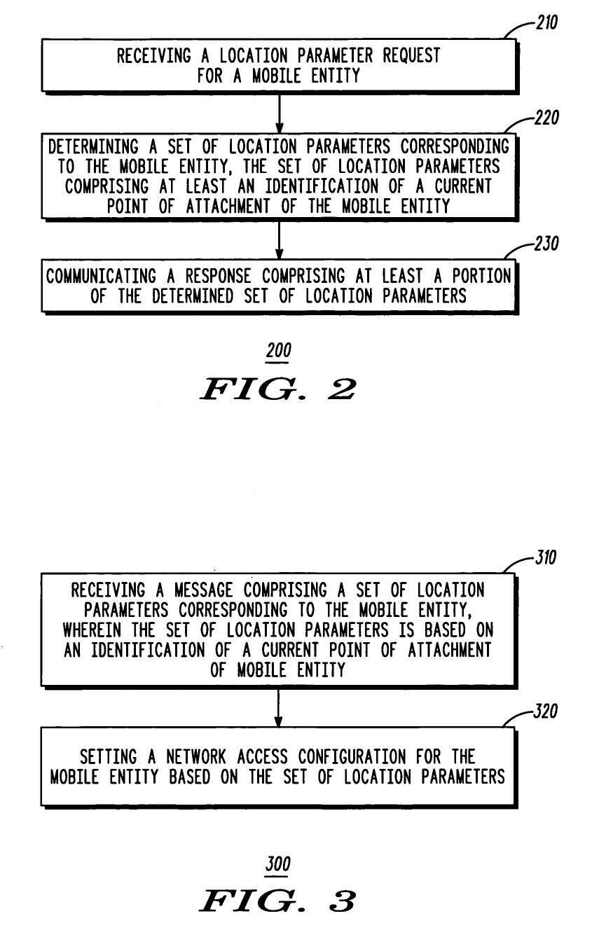

FIGS. 2 and 3 illustrate flow diagrams of methods 200 and 300, respectively, in accordance with embodiments of the present invention. Method 200 may be performed, for instance, in one or more of a location server, a HA, a AAA server and a VPN gateway. Method 300 may be performed in an entity (including a mobile or fixed entity) attached to network 100, such as a router or a host (including a mobile network node (MNN) attached to a mobile network behind a mobile router). In the following implementation described by reference to FIG. 1, method 200 is performed in MVPN server 110, and method 300 is performed in MR1 and in MR2 as these entities power up in network 100. For purposes of the implementation described herein, it is assumed that both MR1 and MR2: have CEN 105 as their home domain; use MVPN server 110 as their HA; and have as their home subnet the subnet to which server 110 is attached.

Method 200 comprises the steps of: determining (220) a set of location parameters corresponding to the mobile entity, the set of location parameters comprising at least an identification of a current point of attachment of the mobile entity; and communicating (230) a message comprising at least a portion of the determined set of location parameters for use in setting a network access configuration in a mobile entity. In one embodiment, the set of location parameters is determined in response to receiving (210) a location parameter request for a mobile entity, and the message is a response to the location parameter request. In another embodiment, the location parameter request and response can be secured using any number of methodologies such as, for instance, user or device authentication, encryption, etc. For illustrative purposes, a secured request and response is described as an authenticated request and response, but these particular implementations are in no way meant to limit the available scope of coverage of the embodiments described herein.

In other embodiments, the location parameter request and response can comprise various formats including, but not limited to: a Mobile IP registration request and reply; a Mobile IP binding update and acknowledgement; an Internet Key Exchange (IKE) request and reply; a Dynamic Host Control Protocol (DHCP) request and reply; a AAA request and reply; a proprietary request and reply or a combination of these messages. Moreover, skilled artisans will realize that any combination of the steps of method 200 can be performed by one or more logical entities alone or in combination that may or may not be co-located. In one embodiment, for example, a HA may be in communication with a mobile entity for performing steps 210 and 230, whereas step 220 may be performed in a location server and communicated to the HA. In another embodiment, the mobile router may provide a portion of the location parameters.

Method 300 comprises the steps of: receiving (310) a message comprising a set of location parameters corresponding to the mobile entity, wherein the set of location parameters is based on an identification of a current point of attachment of the mobile entity; and setting (320) a network access configuration for the mobile entity based on the set of location parameters. It should further be understood by those of ordinary skill in the art that similarly to method 200, method 300 may likewise in another embodiment comprise an additional step of communicating a location parameter request for a mobile entity and that the message of step 310 is a response thereto. Moreover, the location parameter request and response may likewise be authenticated and may further comprise one of: a Mobile IP registration request and reply; a Mobile IP binding update and acknowledgement; an IKE request and reply; a DHCP request and reply; and a AAA request and reply.

The location server may use a variety of schemes individually or in combination to determine the location (e.g., point of attachment) of the mobile entity. For example it may compare the CoA of the mobile entity to a set of prefixes that are considered secure to determine whether the mobile entity has a CoA that belongs to a network that is considered secure. It may also check the presence of a Network Address Translator (NAT) in the path from the mobile entity to the location server, as explained in more detail below, and determine the point of attachment of the mobile entity based on the network address translation of the mobile entity's CoA. Other techniques such as sending a packet to the mobile entity with TTL set to 1, a maximum size packet with a do not fragment bit set to 1, etc., may also be used.

Once the mobile entity's point of attachment to the network is determined, an identification of the mobile entity's location may be sent to the mobile entity, or the mobile entity may be instructed to use a particular network access policy or configuration setting. A network access configuration setting is a setting or configuration in the mobile entity that controls how the mobile entity accesses the network at its point of attachment and how the mobile entity transmits and receives packets on the network. These network access policies may be sent dynamically to the mobile entity. Moreover, such policies may include, but are not limited to: a set of hosts and/or domains for which a VPN should be used; a set of hosts and/or domains for which reverse tunneling should be used; a set of hosts and/or domains for which a bypass mode can be used; a web proxy; etc. The network access policy may also indicate other parameters such as, for instance, if the mobile entity is inside a 3GPP domain or an outside domain such as WiMAX, which may in turn enable the mobile entity to use a preconfigured set of policies. In addition, a combination of preconfigured policies and dynamic policy updates can also be used.

Returning now to the implementation wherein MR1 and MR2 power-up in network 100, we look first at MR1. The following implementations will be described by reference to entities within network 100 being configured to implement MIPv4. However, skilled artisans will realize that in other applications entities may be configured to implement MIPv6 without departing from the scope of the embodiments described herein.

Upon power-up, MR1 is connected to WLAN 145 via AP1 using a wireless link 160 and may need to authenticate to WLAN 145. If so, MR1 proceeds with such authentication in accordance with suitable protocols depending on the authentication mechanism used by WLAN 145. MR1 may then obtain an IP address (i.e., a CoA) on WLAN 145. In this instance, since MR1 is directly connected to the infrastructure, it will receive a co-located CoA. However, those skilled in the art will realize that in another embodiment, MR1 may connect through a mobility agent such as a foreign agent, without departing from the scope of the embodiments described herein, and receive the IP address of the foreign agent as its CoA. Moreover, if MR1 does not already share a security association with AAA server 115, it acquires one using any suitable means. For example, MR1 may be pre-configured with a certificate (e.g., a public key infrastructure (PKI) certificate) for dynamic creation of an AAA key using a certificate-based key establishment method or may be pre-configured with a shared key with AAA server 115, as is well known in the art.

MR1, also using any suitable means, obtains an IP address of a server in its home domain CEN 105 to which it can forward a registration request so that packets destined to MR1 may be received at its current point of attachment. For example, in one embodiment MR1 may perform a DNS look-up for a preconfigured server (e.g., server 110 directly or a proxy server that eventually assigns server 110 as it the HA for MR1) hostname and obtains an IP address for the server. For ease of illustration, it is assumed that MR1 uses this method to discover the IP address for MVPN server 110 and constructs a registration request to its HA using standard Mobile IP, comprising the MVPN server 110 IP address as the destination address, and its CoA as the source address.

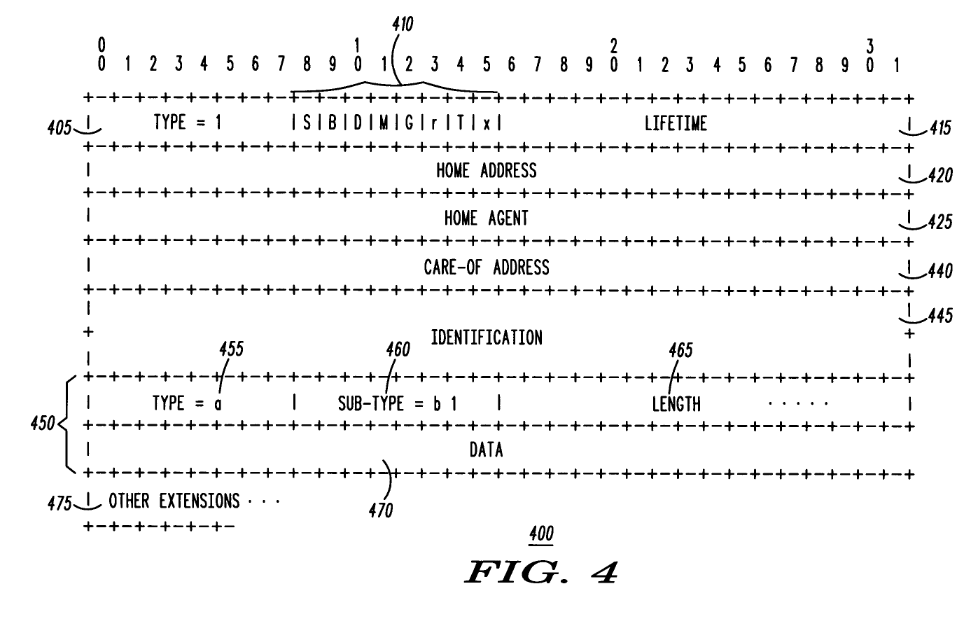

FIG. 4 shows an illustrative registration request 400 in accordance with MIPv4 that may be constructed by MR1. Registration request 400 comprises: a TYPE field 405, wherein a Type=1 identifies the message as a registration request; various fields 410 that are defined in RFC 3344 and will not be further described here in the interest of brevity; a Lifetime field 415 that identifies the number of seconds remaining before the registration is considered expired, wherein a value of zero indicates a request for deregistration; a Home Address field 420 that identifies on IP address for MR1 on its home subnet; a Home Agent field 425 that identifies the IP address of MR1's HA MVPN server 110; a Care-of Address field 440 that identifies MR1 CoA on WLAN 145; an Identification field 445 that comprises a 64-bit number, constructed by MR1, used for matching registration requests with registration replies, and for protecting against replay attacks of registration messages; a location extension 450 in accordance with embodiments herein and optionally other extensions 475, such as, an authentication extension in accordance with MIPv4 and an extension requesting a mobile prefix.

In this implementation, location extension 450 serves as a request to server 110 for location information and other related information, and is also referred to herein as a location parameter request. Location extension 450 can be formulated in a number of ways as will be understood by a skilled artisan, and the location extension 450 illustrated herein is demonstrative of one such embodiment. In this implementation one location extension is used. However, skilled artisans will realize that one or more location extensions may be present to provide location and the corresponding configuration related information. Location extension 450 comprises a TYPE field 455, wherein Type=a identifies the extension as a location extension. A SUB-TYPE field 460, wherein Sub-Type=b identifies the type of location parameters requested based on the value of “b.” The values of “b” may comprise, for example, an location for MR1, a security action or security configuration for MR1, internal topology information such as identities of secured subnets, etc., bypass route information, etc. A Length field 465 identifies the length of the extension, and a Data field 470, wherein the actual data in Data field 470 may depend on the “b” value in the SUBTYPE filed. This extension may also be used to indicate the network access configuration setting for the present location by setting “b” to indicate a configuration index parameter.

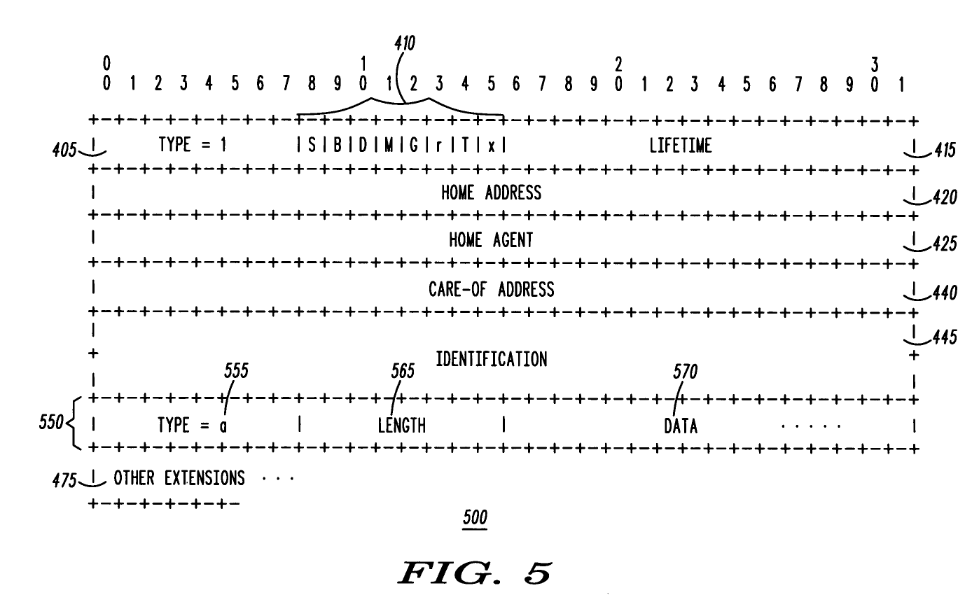

The location parameter request comprising location extension 450 may be sent, for instance, when the location information requested or communicated may be of different types. However, in another embodiment only one type of location information might be exchanged, wherein the one type may be for instance one of the “b” values listed above for the SUBTYPE field 460. FIG. 5 illustrates a registration request 500 that may be used when only one type of location information is exchanged. Registration request 500 includes fields 405, 410, 415, 420, 425, 440 and 445 that are identical to those fields identically labeled in FIG. 4, the explanation of which will not be repeated here for the sake of brevity. Moreover, similar to location extension 450 of registration request 400, registration request 500 further comprises a location extension 550 that serves as the location parameter request. Location extension 550 comprises a TYPE field 555 (similar to TYPE field 455), wherein Type=a identifies the extension as a location extension and further comprises a Length field 565 and a Data field 570. The difference is that location extension 500 does not include a SUBTYPE field, since only one type of location information is communicated. Registration request 500 may also optionally comprise the additional extensions 475, for instance, as described above by reference to FIG. 4.

After constructing the registration request, MR1 encapsulates the registration request with headers comprising its CoA as the source IP address and the server 110 IP address as the destination address and sends the registration request to MVPN server 110 using standard Mobile IP. Server 110 authenticates MR1 using AAA server 115. The authentication is performed, in one embodiment, by server 110 forwarding the registration request from MR1 to server 115, wherein server 115: performs device authentication using applicable extensions (e.g., an authentication extension) in the registration request; creates a MR-HA and MR-VPN gateway key if necessary; performs user authentication of MR1 if requested by MVPN server 110; and notifies server 110 of a successful authentication and sends any generated keys to server 110.

Upon receiving authentication for MR1 (hence, receiving an authenticated location parameter request) and the MR-HA and MR-VPN gateway keys if appropriate, MVPN server 110 can continue to process the registration request and also create the appropriate security associations. If a mobile prefix is requested (as it generally would be since MR1 is a mobile router), server 110 allocates such a mobile prefix. Since a location parameter request, in the form of a location extension, is present in the registration request server 110 determines a set of one or more location parameters corresponding to the mobile entity.

The location parameters may include, but is not limited to, an location of MR1 or the identification of the current point of attachment to the network of MR1, for example, as characterized by an IP subnet to which MR1 is attached, an identity of an access node to which MR1 is attached, a network operator identification (ID) such as a 3G operator ID. MVPN server 110 can use information in the registration request, in this case the CoA for MR1, to determine MR1's location. Server 110 can compare the MR1 CoA to its own NAI to determine whether MR1 is “home” or in other words is attached to a common subnet as server 110. Server 110 is also ideally aware of all of the CEN 105 prefixes (e.g., through pre-configuration or other suitable access to such information) to detect that MR1 is within the CEN even when it is not at home on its home subnet. Where MR1 is not determined to be home and not determined to be within the CEN 105, it can be assumed that MR1 (as in this case) is in a foreign domain outside of the CEN 105 domain.

Since some foreign networks may comprise a Network Address Translator (or “NAT”), MVPN server 110 also ideally comprises a mechanism for detecting whether the registration request has undergone a network address translation within the foreign network so that server 110 can accurately identify the current subnet to which MR1 is attached. In one embodiment, server 110 can detect that such a network address translation has occurred by comparing the source IP address in the IP header of the registration request with the CoA in field 440 of the registration request. If the two addresses are different, it can be assumed that the registration request has undergone a network address translation. In that case, when server 110 sends a registration reply to MR1 it modifies the Mobile IP tunnel between itself and MR1 with a UDP header (to facilitate UDP tunneling) in order to facilitate traversal of the NAT in the foreign network.

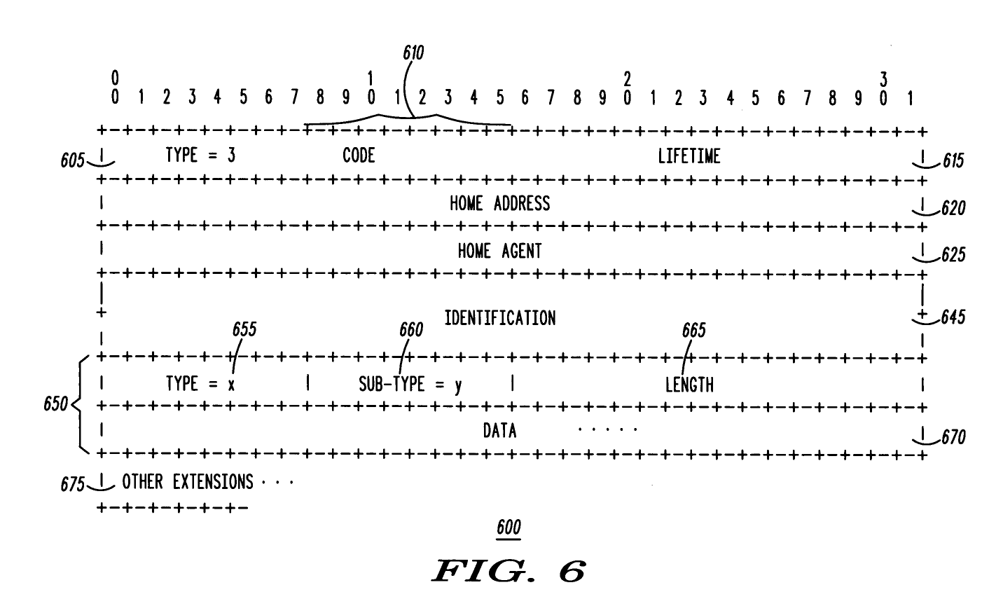

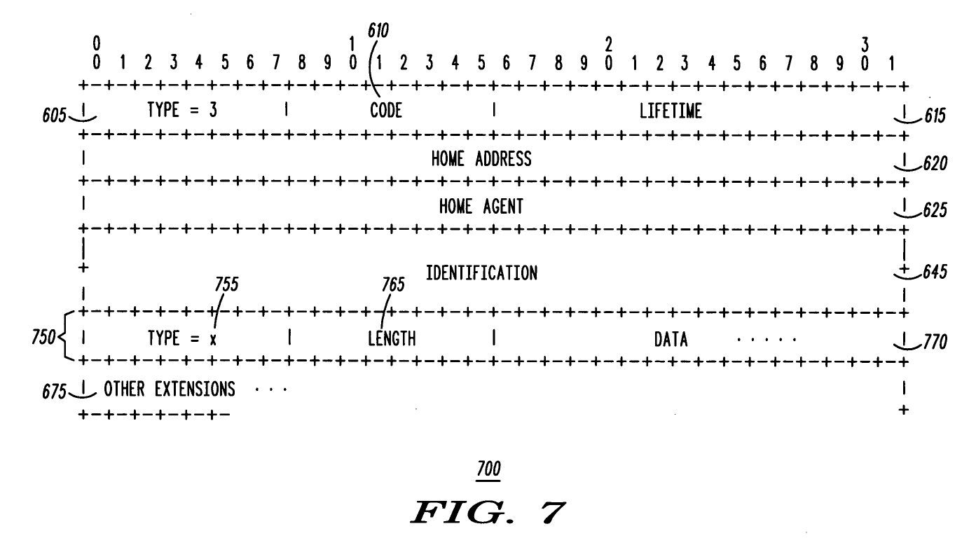

Upon determining the set of location parameters corresponding to MR1, MVPN server 110 constructs a registrations reply message to MR1. The registration reply includes at least a portion of the location parameters that it has determined and further includes any keying material received from AAA server 115 for MR1. FIGS. 6 and 7 illustrate, respectively, registration reply messages 600 and 700. Registration reply 600 corresponds to and may be sent in response to registration request 400, and registration reply 700 corresponds to and may be sent in response to registration request 500.

Registration reply 600 comprises: a TYPE field 605, wherein a Type=3 identifies the message as a registration response; a Code field 610, which corresponds to fields 410 in the registration request, is defined in RFC 3344 and will not be further described here in the interest of brevity; a Lifetime field 615 that identifies the number of seconds remaining before the registration is considered expired and is generally copied from the Lifetime field 415 in the registration request; a Home Address field 620 that identifies an IP address for MR1 on its home subnet; a Home Agent field 625 that identifies the IP address of MR1's HA (e.g., MVPN server 110); an Identification field 645 that comprises the 64-bit number constructed by MR1 and used for matching registration request 400 with this registration reply; a location extension 650 in accordance with embodiments herein and optionally other extensions 675, such as, an authentication extension in accordance with MIPv4 and an extension providing a mobile prefix.

In this implementation, location extension 650 serves as a response to MR1 for location information and other related information. Location extension 650 can be formulated in a number of ways as will be understood by a skilled artisan, and the location extension 650 illustrated herein is demonstrative of one such embodiment. Location extension 650 comprises a TYPE field 655, wherein Type=x identifies the extension as a location extension. A SUB-TYPE field 660, wherein Sub-Type=y identifies the type of location parameters provided based on the value of “y.” The values of “y” may comprise, for example, the same values as for “b” in the registration request 400, which includes a location for MR1, a security action or security configuration for MR1, internal topology information, bypass route information, etc. Typically, the value “y” selected in the registration reply will be the same as the value “b” in the registration request, so that server 110 provides the appropriate location parameter(s) as requested by MR1. A Length field 665, and a Data field 670 comprises the actual data associated with the response to MR1's location parameter request. The actual data in Data field 670 generally depends on the “y” value in the SUBTYPE field and comprises at least a portion of the set of location parameters determined by server 110.

Following are examples of the data that may comprise Data field 670. Where the SUBTYPE field 660 has a value corresponding to a location (e.g. the identification of the current point of attachment of MR1), separate values could for instance be used in the Data field 670 to indicate the different locations, e.g., home, within CEN 105 but not on the home subnet, within a foreign domain outside of the CEN 105 domain, etc. In the case where server 110 communicates location information, MR1 may be configured for using this information to determine and modify its configuration settings such as its network access configuration settings. In this case, the value or data in the Data field 670 would indicate that MR1 was attached to a foreign domain, and MR1 could in turn (upon authenticating the registration reply such that an authenticated response was received) use the data in Data field 670 to set its mobility configuration for using Mobile IP tunneling and to set its security configuration for using VPN tunneling, based on being attached in the foreign domain.

In the case where the SUBTYPE field has a value corresponding to a security action, Data field 670 may comprise a network access configuration setting instruction to MR1 as a location parameter to cause MR1 to configure, for example, its mobility and/or VPN settings based on its current attachment to the network. The configuration setting instruction may comprise, for instance, full VPN tunneling, message authentication only, no VPN (e.g., for any MR1 outgoing traffic), Mobile IP tunneling, no Mobile IP tunneling, etc. In this case, the configuration instruction might comprise full VPN and Mobile IP tunneling based on MR1 being attached in a foreign domain.

In the case where the SUBTYPE field has a value corresponding to internal topology information, Data field 670 may comprise, for example, the internal topology for at least a potion of the routers and hosts in CEN 105 and/or WLAN 145. This may, in one embodiment, enable MR1 to use optimized routing schemes.

In the case where the SUBTYPE field has a value corresponding to bypass route information, Data field 670 may comprise a network access configuration setting instruction to MR1 as a location parameter to cause MR1 to configure its bypass route or bypass mode settings based on its current attachment to the network. Bypass routing is where an entity bypasses the VPN tunnel established with the VPN gateway for a portion or even for all of its outgoing traffic. For this bypass routing, instead of using the VPN gateway as a default router, the entity uses the local gateway on the subnet to which the entity is attached. Moreover, bypass routes may be based on one or more criteria such as, for instance, port number, IP address, etc. MR1, upon receiving such an instruction, dynamically configures its bypass settings in accordance therewith.

For example, the configuration setting instruction may instruct MR1 to bypass the VPN tunnel for all local communication. This instruction may contain certain other limitations such that the bypass settings are only implemented during certain times such as during high traffic times and further that during the times that the bypass settings are implemented that MR1 performs local caching of data. Those skilled in the art will realize that other such limitations and parameters may be included in the configuration setting instruction depending on the particular application. Moreover, in other embodiments, the configuration setting instruction may be only a temporary instruction that is based upon one or more reconfiguration parameters. One such reconfiguration parameter may be that MR1 continue the implementation of the current bypass settings until it receives a subsequent instruction to cancel the configuration setting instruction and/or the current bypass settings and to correspondingly reconfigure the network access configuration in the mobile entity. The subsequent reconfiguration instruction may be communicated to MR1 using any suitable means such as, for instance, a subsequent message from MVPN server 110, a timer timing out, pre-configuration in MR1, etc.

Returning for a moment to Data field 670, it should be understood by skilled artisans that in other embodiments the data comprising Data field 670 may include other location parameters such as the specific type of network to which an entity is attached, e.g., 802.11, 802.16, GPRS, etc. The entity may use this information contained in the authenticated response 600, for example, to further optimize its settings such as those associated with particular applications residing on the entity. By reference again to FIG. 6, the location parameter response comprising location extension 650 can be sent when the location information requested or communicated is of different types. However, in another embodiment (as mentioned above) only one type of location information might be exchanged, wherein the one type may be for instance one of the “y” values listed above for the SUBTYPE field 660.

FIG. 7 illustrates a registration reply 700 that may be used when only one type of location information is exchanged. Registration reply 700 includes fields 605, 610, 615, 620, 625 and 645 that are identical to those fields identically labeled in FIG. 6, the explanation of which will not be repeated here for the sake of brevity. Moreover, similar to location extension 650 of registration reply 600, registration reply 700 further comprises a location extension 750 that serves as the location parameter response. Location extension 750 comprises a TYPE field 755 (similar to TYPE field 655), wherein Type=x identifies the extension as a location extension and further comprises a Length field 765 and a Data field 770. The difference is that location extension 750 does not include a SUBTYPE field, since only one type of location information is communicated. Registration reply 700 may also optionally comprise the additional extensions 675, for instance, as described above by reference to FIG. 6.

After constructing the registration reply, server 110 encapsulates the registration reply with headers comprising its IP address as the source IP address and the MR1 CoA address as the destination address and sends the registration reply to MR1 using standard Mobile IP. MR1 authenticates server 110 using AAA server 115, thereby generating an authenticated response comprising the location parameters. With receipt of the authenticated response (e.g., the authenticated registration reply) MR1 receives, for example, a mobile prefix if one was requested, one or more location parameters, shared keys (to enable establishment of security associations) between MR1 and MVPN server 110, etc. MR1 can now perform IKE with MVPN server 110 to establish the IPSec security association (for establishing the VPN tunnel between itself and server 110) using the shared keys and can proceed to communicate over network 100 in accordance with its network access configuration settings.

It should be readily understood by those skilled in the art that the embodiments described herein are not limited to the case of a mobile router powering up in a foreign domain. The detailed description above with respect to MR1 is equally applicable when a mobile router powers up in CEN 105 or even on its home subnet as is the case for MR2. In this instance, a registration response/reply such as was described above may be exchanged between MR2 and server 110 for communicating one or more location parameters to MR2 so that MR2 can configure itself in accordance with these location parameters. Moreover, it should be further understood that the embodiments herein are applicable to host entities (including MNNs attached to a mobile network behind a mobile router, both local MNNs and visiting MNNs) powering up on network 100. In addition, the embodiments described herein are applicable not only upon power-up of an entity, but also upon hand-off of a mobile entity from one subnet to another, for instance for a hand-off of MR1 from WLAN 145 to WLAN 130.

Even more embodiments can be implemented in accordance with the teachings herein. For example, in another embodiment the location parameters can be communicated to an entity in binding update and binding acknowledgement messages exchanged between the entity and its HA in accordance with MIPv6. In such an embodiment, a location extension could be used to communicate a location parameter request and location parameter response (comprising the location parameter(s) corresponding to the entity) in a similar manner as described above when using the registration request/reply messaging. Likewise, the location parameter request and response can comprise: an IKE request and reply comprising a location extension; a DHCP request and reply comprising a location extension; a AAA request and reply comprising a location extension.

In yet another embodiment, location parameters (e.g., location information) may be communicated to an entity in other ways. For instance, when the HA detects that a ME is attached to its home subnet, it may send the registration reply back to the HoA of the ME, rather than the CoA. Accordingly, if the ME sends a registration request with a CoA and it receives a registration reply on its HoA, the ME may assume that it is home. Another approach could be for the HA to set the CoA field inside the registration reply to the same value as the HoA of the ME, thereby indicating that it has de-registered the ME and implicitly implying that the ME is attached to its home subnet. In still another embodiment, the location parameter request and response that includes the location parameter(s) communicated to the ME may be exchanged using other types of message signaling between the ME and its HA, such as various proprietary (non-standardized) message signaling.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What is claimed is:

1. A method comprising the steps of:
receiving allocation parameter request for a mobile entity;
determining a set of location parameters corresponding to the mobile entity, the set of location parameters comprising at least an identification of a current point of attachment of the mobile entity; and
communicating a response comprising at least a portion of the determined set of location parameters.

2. The method of claim 1, wherein:
the location parameter request is included in at least one of a Mobile Internet Protocol (IP) registration request, a Mobile IP binding update, an Internet Key Exchange (IKE) request, a Dynamic Host Configuration Protocol (DHCP) request and an Authentication Authorization and Accounting (AAA) request;
the response is included in at least one of a Mobile IP registration reply, a Mobile IP binding acknowledgement, an IKE reply, a DHCP reply and an AAA reply; and
the set of location parameters is determined based on information included in one of the registration request, the binding update, the IKE request, the DHCP request and the AAA request.

3. The method of claim 2, wherein the information included in at least one of the registration request, the binding update, the IKE request, the DHCP request and the AAA request comprises a care-of address corresponding to the mobile entity.

4. The method of claim 3, wherein the care-of address for the mobile entity has undergone a network address translation, the method further comprising the steps of:
detecting a network address translation of the care-of address for the mobile entity; and
determining the identification of the current point of attachment of the mobile entity based on the network address translation of the care-of address for the mobile entity.

5. The method of claim 1, wherein the response comprises the identification of the current point of attachment of the mobile entity.

6. The method of claim 1, wherein the set of location parameters further comprises a network access configuration setting instruction corresponding to the mobile entity based on the identification of the current point of attachment of the mobile entity, and the response comprises the network access configuration setting instruction for use in setting a network access configuration in the mobile entity.

7. The method of claim 6, wherein the network access configuration setting instruction comprises an instruction to the mobile entity to bypass a Virtual Private Network (VPN) tunnel when communicating at least a portion of its outgoing traffic.

8. The method of claim 7, wherein the network access configuration setting instruction is a temporary instruction based upon at least one reconfiguration parameter.

9. The method of claim 8, wherein the at least one reconfiguration parameter comprises communicating a subsequent instruction to reconfigure the network access configuration in the mobile entity.

10. The method of claim 1, wherein the location parameter request and the response are secured.

11. Apparatus for location determination comprising:
a storage device; and
a processor coupled to the storage device executing instructions stored in the storage device for causing the apparatus to perform the steps of:
receiving a location parameter request for a mobile entity;
determining a set of location parameters corresponding to the mobile entity, the set of location parameters comprising at least an identification of a current point of attachment of the mobile entity; and
communicating a response comprising at least a portion of the determined set of location parameters.

12. The apparatus of claim 11 comprising at least one of a home agent, a location server, an Authentication Authorization and Accounting (AAA) server, and a Virtual Private Network (VPN) gateway.

13. A method comprising the steps of:
receiving a message comprising a set of location parameters corresponding to a mobile entity, wherein the set of location parameters is based on an identification of a current point of attachment of the mobile entity; and
setting a network access configuration for the mobile entity based on the set of location parameters.

14. The method of claim 13 further comprising the step of communicating a location parameter request for the mobile entity, wherein the message is a response to the location parameter request.

15. The method of claim 14, wherein the location parameter request is included in at least one of a Mobile Internet Protocol (IP) registration request, a Mobile IP binding update, an Internet Key Exchange (IKE) request, a Dynamic Host Configuration Protocol (DHCP) request and an Authentication Authorization and Accounting (AAA) request, and the response is included in at least one of a Mobile IP registration reply, a Mobile IP binding acknowledgement, an IKE reply, a DHCP reply and an AAA reply.

16. The method of claim 13, wherein the method is performed in one of a mobile router and a mobile host.

17. The method of claim 16, wherein the mobile host is a mobile network node.

18. The method of claim 13, wherein the set of location parameters comprises the identification of the current point of attachment of the mobile entity, the method further comprising the step of determining the network access configuration for the mobile entity.

19. The method of claim 13, wherein the network access configuration comprises the mobile entity bypassing a Virtual Private Network (VPN) tunnel when communicating at least a portion of its outgoing traffic.

20. The method of claim 13, wherein the set of location parameters comprises a network access configuration setting instruction corresponding to the mobile entity based on the identification of the current point of attachment of the mobile entity, and the network access configuration for the mobile entity is set based on the network access configuration setting instruction.
